(19) United States
(12) Patent Application Publication
(10) Pub. No.: US 2015/0165580 A1
(43) Pub. Date: Jun. 18, 2015

(54) Power Drill Alignment and Depth Measurement Device

(71) Applicant: James HOLLAND, Larchmont, NY (US)

(72) Inventor: James HOLLAND, Larchmont, NY (US)

(21) Appl. No.: 14/279,558

(22) Filed: May 16, 2014

Related U.S. Application Data
(60) Provisional application No. 61/915,656, filed on Dec. 13, 2013.

(51) Int. Cl. B23Q 17/22; B23B 49/00

(52) U.S. Cl. CPC B23Q 17/2275; B23B 49/00; B23B 2270/32; B23B 2270/48

(57) ABSTRACT

The present invention provides a device and method for aligning a drill bit of a hand drill to a specific angle—typically, perpendicular to the surface to be drilled. Concurrently, the invention provides a method to measure the depth of the drilled hole. The device of the invention comprises: (a) a signal source that generates a signal (typically a light pattern) that varies in response to changes in angle or depth of the drill bit; and (b) a holder to which the signal source is attached, the holder is mounted to the drill chuck of the drill and moves with its rotation. By using of the present invention, an image is generated that changes with angle or depth changes of the drill bit. This image is used by the operator to orient the angle of the drill bit or to determine the depth of the hole drilled.

The present invention relates generally to aligning power hand held tools with respect to a target surface of a work piece. The invention is especially useful for “in-field” or in-situ use—as opposed to in-shop or in other controlled environments. Preferably, the invention provides a hand drill operator with visual confirmation of the proper angle of alignment with regard to a work piece surface, and the distance the drill bit has traveled through the work piece material relative to the desired depth.

### BACKGROUND OF THE INVENTION

For non-professionals (e.g., boaters, campers, homeowners) or for situations outside of a machine shop (e.g., field construction sites, home projects, boats, etc.), drilling holes at specific angles to a surface offers daunting challenges—especially if the surfaces to be drilled are not in a horizontal or vertical orientation (e.g. at an odd angle or curved). Other challenges include a surface that is not static in its alignment, such as on a boat, in difficult locations such as small, remote, or hard to reach areas (e.g. inverted or overhead areas) that do not allow a physical or visual alignment of the hole to be drilled, the drill, and the operator. The depth at a hole is to be drilled presents a challenge as well as the operator outside the machine or tool shop does not have access to a drill press that has drill stops built in. The alternative of carrying depth stops for each drill bit size is cumbersome and the stops themselves can damage or deface the material surface and/or the drill bit itself.

The result of a misaligned drilled hole or a hole drilled to the wrong depth can be exceptionally expensive on installed items and structures on which drilling a hole is performed in both time and material.

There have been many attempts to ensure alignment of a drilling operation to the surface being drilled, albeit with the different aspects of alignment (i.e., distance, intersection to the surface, alignment to a single plane or line). Generally, these devices and methods fall into two categories, optical and mechanical. While these devices and methods are feasible, the lack of wide or commercial adoption is indicative of their sub-optimal design. Most of the current devices are unable to be used in difficult locations, such as small areas, remote or hard to reach areas that do not allow a physical or visual alignment of the hole to be drilled, require ancillary equipment, provide alignment only on a single plane, and/or are expensive.

Optical solutions to date typically do not provide sufficient feed back to the human eye to ensure alignment. Furthermore, some optical devices do not target the immediate vicinity of the hole being drilled, which negates their usefulness in small areas or curved surfaces and/or requires operator/user to focus on the equipment read outs, not on the surface to be drilled.

Mechanical or structural devices for aligning or positioning a drill usually require physical contact with the surface of the item to be drilled as part of the alignment process. This can create significant weight and/or safety issues. These devices also can be especially difficult to use or impractical on large, uninterrupted surfaces. A number of the devices are useful only with drill presses, and cannot be used with hand drills. Some are only for use in shops or locations where the environment is controlled (that is, not for fieldwork).

All of the devices provide alignment only to a single plane (planar alignment) or to a surface reference element other than a point, such as a line. Some devices can be used only on purely horizontal or vertical planes, as they require ancillary equipment, which cannot be used effectively on remote, hard to reach, and inverted surfaces. Other prior art devices require permanent modification to the drill for installation, and therefore removal and re-use on another drill is not viable due to the effort required to install and re-calibrate the unit. Other devices require repeated alignment and calibration during installation and use thus slowing down the drilling operation.

Essentially all of the existing devices and methods are comparatively expensive when compared to the present invention. Additionally, they do not provide a simple and economical way to align drilling that can be used with, and attached to, existing home-type hand drills, both corded and cordless.

Moreover, none of the optical approaches discussed above provides means for managing the depth of the hole being drilled with a power hand drill. Most devices for managing drill hole depth are mechanical—and involve the use of a stop on the drill bit that can damage or deface the surface, the drill, and/or the drill bit. Other solutions involve marking the drill bit with a piece of tape or the like, or physically measuring and marking the drill bit to the desired depth. These solutions are temporary and can deface the drill bit over time—reducing its efficacy and usefulness.

### SUMMARY OF THE INVENTION

The present invention provides devices and methods for determining angle and/or depth of a drill bit with respect to a work piece surface. The device of the invention comprises:
at least one signal source that generates a signal that varies in response to changes in angle or depth of the drill bit, the signal source being capable of moving with rotation of the drill bit; and
a holder to which the signal source is attached, the holder being capable of being mounted to a drill chuck and moving with rotation of the drill bit.

In another embodiment, the invention provides a device that attaches to a drill chuck of a hand drill which can be used for aligning a drill bit or determining its depth with respect to a work piece surface. The device comprising at minimum a light source and means for attaching said light source to the drill chuck—whereby an image is projected onto the surface and the image can be used to assess orientation or depth of the drill bill with respect to the surface.

The method of the present invention comprises:
inserting the drill bit into a drill chuck;
mounting a holder onto the drill chuck, the holder being capable of moving with rotation of the drill bit;
attaching a light signal source to the holder, the light signal source being capable of moving with rotation of the drill bit and of generating an image or trace that changes with angle or depth changes of the drill bit;
generating the image while drill is in use; and
using the image to orient the angle of the drill bit or to determine the depth of the drill bit with respect to the work piece surface.

The invention provides an efficient and economical means for alignment of drill bits on a variety of surfaces, including flat and curved surfaces, moving surfaces, small area surfaces, or remote or hard to reach surfaces, or even surfaces that do not allow observation of the area being drilled.

### BRIEF DESCRIPTION OF THE FIGURES

FIG. 1 is an elevation view of a preferred embodiment of the invention as it interfaces and attaches to a typical drill chuck.

FIG. 2 shows a top plan view of the preferred embodiment of FIG. 1.

FIG. 3 shows a representation of the light trace pattern on the surface as produced by preferred embodiments of the invention in an aligned (perpendicular) and misaligned (non-perpendicular) states.

FIG. 4 shows the change of the outer ring diameter, for a preferred embodiment of the invention, as the drill descends into the material to the desired depth at three points through the process; beginning, middle, and end.

FIG. 5 shows a another embodiment of the invention that has the lasers at a fixed angle of incidence relative to the work surface

FIG. 6 shows another embodiment of the invention that utilizes a single laser output set parallel to the drill bit longitudinal axis.

FIG. 7 shows a template that could be used with the embodiment shown in FIG. 6.

FIG. 8 shows aids to assist the operator in drilling holes in areas that are narrow or have a complex surface.

FIG. 9 shows an illustrative design of a template that can be used to drill holes at specified angles, e.g., 30, 45, and 60 degrees.

### DETAILED DESCRIPTION OF THE INVENTION

The present invention is described more fully hereinafter with references to the accompanying figures, in which preferred embodiments are shown. The following description of the preferred embodiments of the invention is presented for the purposes of illustration only. These embodiments are presented to aid in an understanding of the invention and are not intended to, and should not be construed to, limit the invention in any way. In preparing the preferred embodiments of the present invention, various alternatives may be used to facilitate the objectives of the invention. All alternatives, modifications and equivalents that may become obvious to those of ordinary skill upon a reading of the present disclosure are included within the spirit and scope of the present invention.

Additionally, the present disclosure is not a primer on power tools or drills, nor is it a primer on optical or mechanical systems or apparatus for implementing embodiments of the invention described herein. Basic concepts known to those skilled in the industry have not been set forth in detail.

The device of the present invention comprises (a) at least one signal source that generates a signal that varies in response to changes in angle or depth of the drill bit (the signal source being capable of moving with rotation of the drill bit) and (b) a holder to which the signal source is attached (the holder being capable of being mounted to a drill chuck and moving with rotation of the drill bit).

The method of the present invention comprises (a) inserting the drill bit into a drill chuck; (b) mounting a holder onto the drill chuck (the holder being capable of moving with rotation of the drill bit), (c) attaching a light signal source to the holder (the light signal source being capable of moving with rotation of the drill bit and of generating an image that changes with angle or depth changes of the drill bit), (d) generating the image while drill is in use, and (e) using the image to orient the angle of the drill bit or to determine the depth of the drill bit with respect to the work piece surface.

The present invention has two key objectives. The first is to provide a system for producing an optical or visual signal indicating the alignment of a drill bit in a hand-held power drill when in use. Typically, the alignment sought is a perpendicular angle to the work surface, but other specific angles can also be achieved using the present invention, e.g. 30, 45 and 60 degree. The second objective is to provide an optical measurement system that indicates the depth of the hole being drilled. In preferred embodiments of the invention, the system indicating the drill depth uses the same visual signals as those associated with the alignment objective.

Although described herein with respect to hand-held drills, it is contemplated that the present invention can be used with a variety of other tools, particularly other hand-held power tools, in order to aid in determining the alignment of the tools or their distance from the work piece surface. Specifically, it is contemplated that the present invention can be used with hand-held drills, hand-held rotary sanders and polishers, hand-held & stand-up floor sanders and polishers, nail guns, welding devices, etc. For some tools that do not have a rotating part—such as nail guns and welders, the use of the present invention may require the incorporation of a motor to rotate the signal source.

It is also contemplated that the present invention can be used in conjunction with templates or trace outlines, which may attach to the drill or lie on the work piece surface, and which may aid an operator in drilling holes at non-perpendicular angles.

The signal source of the present invention projects light and generates a pattern or shape (typically on the work piece surface) as the signal. This signal changes in response to changes in angle or depth of the drill bit. For instance, where the signal source is a laser projecting a light beam at the work piece surface, a circle or ellipse or oval will be generated around the hole being drilled as the drill chuck (and hence the signal source) rotates. If the axis of rotation is perpendicular to the surface, then a circle will form. If the axis of rotation is not perpendicular then an ellipse will form. The changing of shape from ellipse to circle can be use by the operator to determine when the drill bit is perpendicular to the work piece surface.

For desired angles that are not perpendicular, a template can be used—with the signal then being projected onto the template instead of the work piece surface. The template may have traces or designs on it that are used in conjunction with the signal to determine when the drill bit is at the desired angle and/or depth. For instance, the template may have an ellipse trace on it which matches the ellipse formed by the signal when the drill bit is at the desired angle. Alternatively, the template can be set at an angle complementary to the desired drill angle. For instance, if a 30 degree drill angle is desired, the template can be set at a 120 degrees angle to the work piece surface. A circle would then form on the template when the drill bit is at the desired 30 degree angle. The template can be attached or supported by the work piece surface to be drilled or by a remote structure.

Beside templates, the invention may also be used with reference rings, plane extenders, etc. The templates and these other materials may be transparent, translucent or opaque and may be made from a variety of materials, including plastic or paper.

The invention may comprise a plurality of signal sources, each generating its own signal or one signal or a plurality of signals. From instance, several signal sources may be attached to the holder and the holder mounted so that signal sources surround the drill chuck. The signal sources can be adjusted so that they all project light to the work piece surface and generate one circle/ellipse upon rotation of the drill chuck. Alternatively, the signal sources may be adjusted so that they generate multiple circles/ellipses upon rotation of the drill chuck. Also continuous ring(s) of lights may be employed as the signal source(s), preferably with narrow, directional gaps and/or a polarized lens.

In preferred embodiments of the invention, two signal sources are used, each generating a separate circle/ellipse signal on the work piece surface. It has been found that the naked eye can more easily determine when a circle signal is not true when there are two or multiple circle signals of slightly different diameters. For instance, in one embodiment of the invention, the inventive device comprises a signal source that projects a light beam that is essentially parallel to the axis of rotation of the drill chuck and a second signal source that projects a light beam that is not parallel to the axis of rotation of the drill chuck. Upon rotation of the drill chuck, two circles/ellipses are formed. As the drill bit becomes perpendicular to the work piece surface, two circles of different diameters are formed. The naked eye can easily detect if the distance between circles is not constant and hence the circles are not true. In this embodiment, the light beam parallel to the rotational axis may instead be at a slight angle to the axis—up to about 15 degrees in relation to the axis.

The invention also provides means for tracking the depth of the hole being drilled. For instance, in the preferred embodiment described above (where the inventive device comprises a signal source that projects a light beam that is parallel to the axis of rotation of the drill chuck and a second signal source that projects a light beam that is not parallel), two circles are formed when the drill bit is perpendicular to the surface. As the hole is drilled, and the drill chuck and signal sources move closer to the surface, the diameter of the circle formed by the signal source that is not parallel to the axis of rotation decreases. The diameter of the circle formed by the signal source that is parallel to the rotational axis remains constant. The distance between the circles can be correlated to the depth of the hole—the further being zero and the closest being the desired depth. In the above preferred embodiment, if the signal source that is not parallel to the rotational axis is set at a 45 degree angle that intersects the rotational axis, then the distance between the circles would equal the drill bit depth needed to have the circles overlap. In other words, an operator can adjust the height of the non-parallel signal source so that its circle is at a distance from the circle of the parallel signal source that is equal to the desired depth of the drilled hole. As drilling occurs, the circles move closer together. When they overlap, the drilled hole is at the desired depth.

Although the inventive method for indicating hole depth described above is described with the use of a signal source parallel to the rotational axis, the method can also be performed with both signal sources at non-parallel angles—or even with one signal. The invention permits correlation of the desired hole depth to the distance travelled by a signal. With non-parallel signal sources, their heights can be adjusted so that the desired depth is correlated to a specific distance between the circles. With one non-parallel signal source, the desired depth is correlated to the distance between the circle and a fixed point on the work piece surface or elsewhere.

It is also contemplated that the parallel signal source may be replaced with a non-rotating signal source. Instead of a signal source mounted through a holder to the drill chuck, a signal source can be mounted to the drill body or elsewhere and the distance between its signal (e.g., a light point or line) and the circle from the rotating, non-parallel signal source used for correlation to the drilled depth.

To increase the usefulness of the present invention, in preferred embodiments, all signal sources can be adjusted within the holder in order to control the angle of incidence of the signals to the work piece surface; the height of the signals to the work piece surface; the signals' distance from the center of the drill operation (e.g., the position of the drill bit and/or hole to be drilled); etc.

Preferably, said signal source(s) comprise light emitter(s) independently selected from the group consisting of incandescent bulbs, fluorescent bulbs, lasers, and light emitting diodes (LED). The signal source(s) may also include focusing lenses, reflective mirrors, prisms, beam splitters or separators, or other optical devices. In the most preferred embodiments, the signal source is a laser whose light forms a point on the work piece surface when the drill bit is not moving and a circular or elliptical pattern on the surface with rotation of the drill bit.

It is contemplated that the signal source may emit light of differing, multiple or contrasting colors for different environments or user needs. Also the signal source(s) and/or holder may incorporate pre-spin functionality that creates the circular traces on the work surface prior to operating the drill.

The signal source(s) may be attached to the holder in a number of ways—adjustably affixed, permanently affixed at a set angle, or integral to the holder assembly. Adjustably affixed is the preferred method because this allows the user to adjust the angle of incidence of the signal source(s) to accommodate the length of the drill bit, the size of the surface area to be drilled, the surface characteristics, etc. Accordingly, in the most preferred embodiments, the signal source(s) can be pivoted, angled, and/or moved vertically and horizontally with respect to the drill chuck. A set screw assembly or ratchet assembly may be used to adjust the signal source(s) in the holder.

The signal source(s) can also be connected to a pressure switch positioned in the drill chuck so that the signal source(s) will be activated when the tip of the drill bit is pressed against the surface to be drilled.

The holder comprises means for mounting it on a drill chuck. In the preferred embodiments, the holder is a collar that is capable of being removeably mounted on the drill chuck. In the most preferred embodiments, the collar has a rigid outer ring to which the signal source(s) is(are) attached, and a semi-rigid inner ring that is capable of sliding over and securely attaching to the drill chuck. Means of attachment may comprise pressure springs, O-rings, locking teeth, ball bearings on spring cylinders, tightening rings, etc. Other means of attachment are also contemplated, including mounting the holder in a permanent manner with screws, nails, glue, welding, etc. However, mounting in a manner whereby the holder can be easily removed without physical change or damage to the drill chuck is preferred.

The holder may be made from a variety of materials, such as plastic, metal, wood, or flexible wire, or combinations thereof. The material of construction may be selected to accommodate differing drills and drill chucks or differing operating environments (such as extreme cold or heat, in water, underwater, or in caustic vapor, etc.).

It is also contemplated, although not preferred, that the holder and/or signal source(s) can be included as an integral or built-in part of the drill, drill chuck, or drill bit assembly. It is contemplated that drill chuck assemblies that incorporate the signal source(s) of the present invention may be produced. In such assemblies, the holder may be eliminated and/or the signal source(s) may be powered by the power system of the drills. Also micro laser assemblies that attached or are integral to the drill chuck or drill bit may be used as the signal source(s). In this case, the signal source(s) would be mounted directly to the drill chuck or drill bit instead of to the collar on the drill chuck.

The inventive device of the present invention also comprises a power source for powering the signal source(s). In preferred embodiments, the power source is attached to the signal source(s) or the holder or is incorporated in the signal source(s) or holder. Each signal source may have its own power source or the signal sources may share one or more power sources. The power source may comprise a battery, an induction motor driven by the drill rotation, a fuel cell, a solar cell, etc. or may be derived from the electrical or battery power of the drill. In the most preferred embodiments, the power source is a battery. A switch or a plurality of switches may also be present. Each signal source may have a switch or one switch may control all signal sources. The power switch may comprise different operating positions—e.g., on, off, centrifugal on (energizes signal source(s) once the drill chuck is spinning), on via pressure applied to the drill bit tip, etc.

It is also contemplated that the inventive device may be used with wedges or cams or the like in order to offset the holder or the signal source(s) on the drill chuck to accommodate non-perpendicular drill angles. Additionally, the holder can be designed to be inverted or flipped around on the chuck and to project the signal onto a surface remote from the surface being drilled—e.g., a plane parallel and behind the drill unit or a non-adjacent surface to the surface being drilled.

The invention can also be used in conjunction with a unit that can provide electrical signaling and feedback to monitoring equipment for remote or robotic operation, e.g., where the surface to be drilled cannot be visually observed directly.

### DETAILED DESCRIPTION OF PREFERRED EMBODIMENTS

The preferred device of the present invention utilizes a collar that fits onto a power drill spinning chuck. The collar contains to two laser diodes and lenses that projects two separate precise points of light on the surface that is to be drilled. The lasers can be adjusted to modify the angle of incidence on the surface and adjust the location of the points of light on the surface. One laser projects a light beam that is parallel to the drill and drill bit; the other laser projects a light beam that is not parallel to the drill bit. As the drill is operated, the device spins creating two light traces, as seen by the human eye, of different diameters, determined by the operator through the setting of laser angle. Once the drill is perpendicular to the work surface, the traces become prefect circular images and equidistance to the center, identified by the drill bit on the work surface. If the drill is not perpendicular, the traces deform into non-concentric ellipses. By using different angles of incidence of the lasers, the rate of deformation and shape of the trace images on the surface will be different. The differently deformed shape of the trace images relative to each other in conjunction with the lack of equidistance to the drill bit center reference, accentuates and provides a strong visual cue to human eye as to the misalignment. The invention provides perpendicular alignment on an infinite or continuous number of planes (360 degrees), not just in one or two planes as is typical with other devices.

To measure or set a predetermined depth of the hole being drilled, one laser is set parallel to drill bit and other at a 45-degree angle. The laser set at the 45 degree angle is adjusted vertically or parallel to the drill bit such that its light output is equal distance from the drill bit center and overlaps and occupies the same spot on the surface as the light output of the laser source that is parallel with the drill bit. The laser set at the 45-degree angle is then moved vertically upward on the collar to a position equal to the desired depth of the hole being drilled. The light source on the surface will move an equal distance out from the drill bit center due to the geometric properties of a 45-degree right triangle. Once drill operation commences and the drill travels into the material, the outer trace circular image will shrink toward the inner circular image. Once the two trace circles are of an equal radius, the drill has created a hole to the desired depth. This functionality operates concurrently with the alignment functionality.

To drill at common angles to the surface of the material e.g. 30, 45 and 60 degree angles, both lasers are set parallel to the drill bit and when placed in motion, the trace path matches pre-defined elliptical templates for the desired angle that is laid on the surface and centered at the point of hole to be drilled.

The collar is designed utilizing a rigid outer ring to which the lasers, power source, and switch can be attached and an inner semi rigid material such that it will slide over and fit tightly onto to most drill chucks. It is weight balanced both axially and horizontally so not create any unbalance vibration while the unit is spinning. The power source is typically a 3-volt ‘coin’ type but other micro batteries can suffice.

### NUMERICAL INDEX FOR THE FIGURES

1. Drill Chuck
2. Drill Bit
3. Surface to be Drilled
4. Collar
5. Laser Unit (2)
6. Focus Lens, Adjustable (2)
7. Attachment/Adjustment Assembly (2)
8. Power Wires (2)
9. On/Off Switch and Power Source
10. Emitted Laser Beams (2)
11. Pressure Band Springs (4)
12. Counterweight
13. Outer Ring (Black, Non Reflective Material)
14. Reflective Surface (Same Diameter As Laser)
15. Inner Ring (Black, Non Reflective Material)
16. Clear Plexiglas (With Alignment Guides)
17. Open Hole for Drill Bit

What follows is a description of preferred embodiments of the invention with reference to the accompanying figures—whose elements are indicated by the numerical index above.

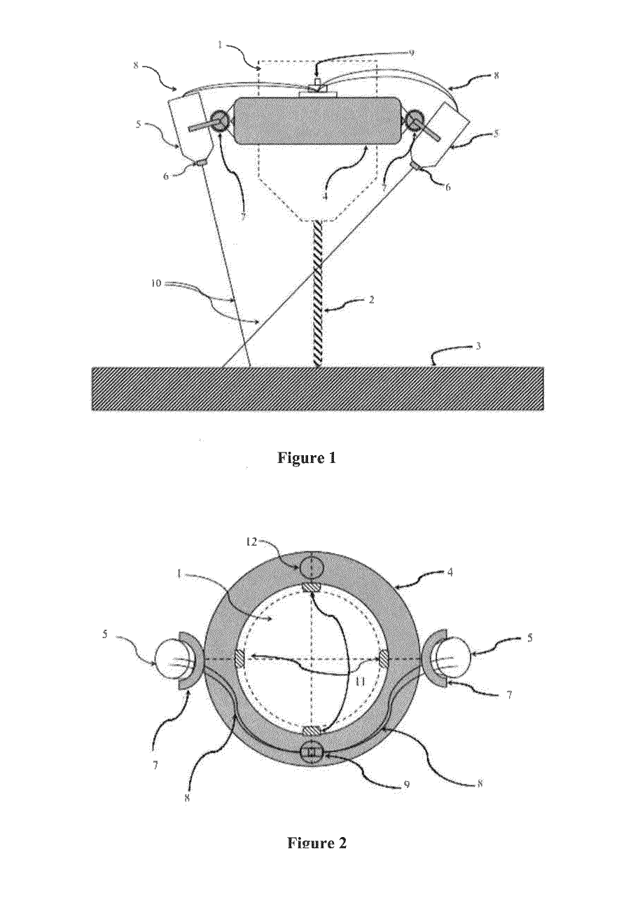

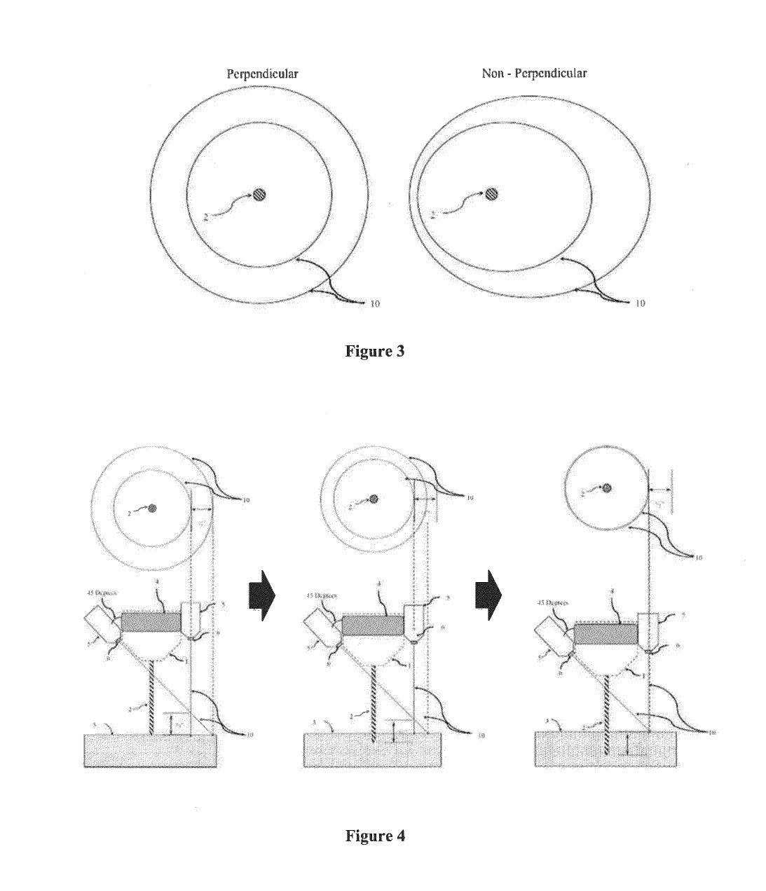

Referring to FIGS. 1 and 2, the illustrated preferred embodiment shows a feature of the present invention where the laser angle of incidence to the surface being drilled can be adjusted. In this preferred embodiment of the invention, two or more lasers (5) are attached to a collar (4) that is designed with cushioning bumpers (11) and is fitted tightly onto the drill chuck (1). The lasers are powered by a battery and switch assembly (9) and connected via wiring (8). The switch may have multiple settings, e.g., on, off, centrifugal on (energizes when spinning), and pressure sensitive that registers when the drill bit (2) is pressed against the surface to be drilled (3). The lasers will also have adjustable lenses (6), typically screw type, to focus the emanated beam (10) on the surface (3) to compensate for differing drill bit lengths and set angles.

The lasers can be set at different angles as measured off the 90 degree vertical of the surface to be drilled through an adjustment assembly (7). The selection of the appropriate angle for each laser is based on the length of the drill bit, the size of the surface being worked on, and the operator's preference. The lasers, in combination, create concentric circles when the drill unit is rotating and perpendicular to the surface being drilled as shown in FIG. 3. Due to the differing angle of incidence and distance from the center point, the concentric circles will undergo differing deformation rates and shapes, when the drill alignment is moved off the perpendicular plane to the surface. This relative change and distance between the two concentric circles and the center, as marked by the drill bit, is easily visible to the human eye. The non-linear deformation rate and shape of the individual circles when the drill unit is not perpendicular reinforces or accents the non-alignment. In addition, the lack of equidistance of the circles to the drill bit tip provides additional, visual, confirmation that the drill is not perpendicular to the work surface. The unit provides alignment on an infinite or continuous number of planes (360 degrees), not just in one or two planes as is typical with other devices.

The collar assembly also holds power wires (8) that connect the laser units to a switch and power source (9). The switch is a 3 position, on, off and centrifugal on, the third position to energized the laser indicator lights only when the unit is attached to the drill chuck (4) and is spinning. A power source (3 volt DC batteries) and switch (9) are also mounted on the collar assembly. A counterweight (11), integral to the collar, is included to balance the weight and position of the switch and power source (9).

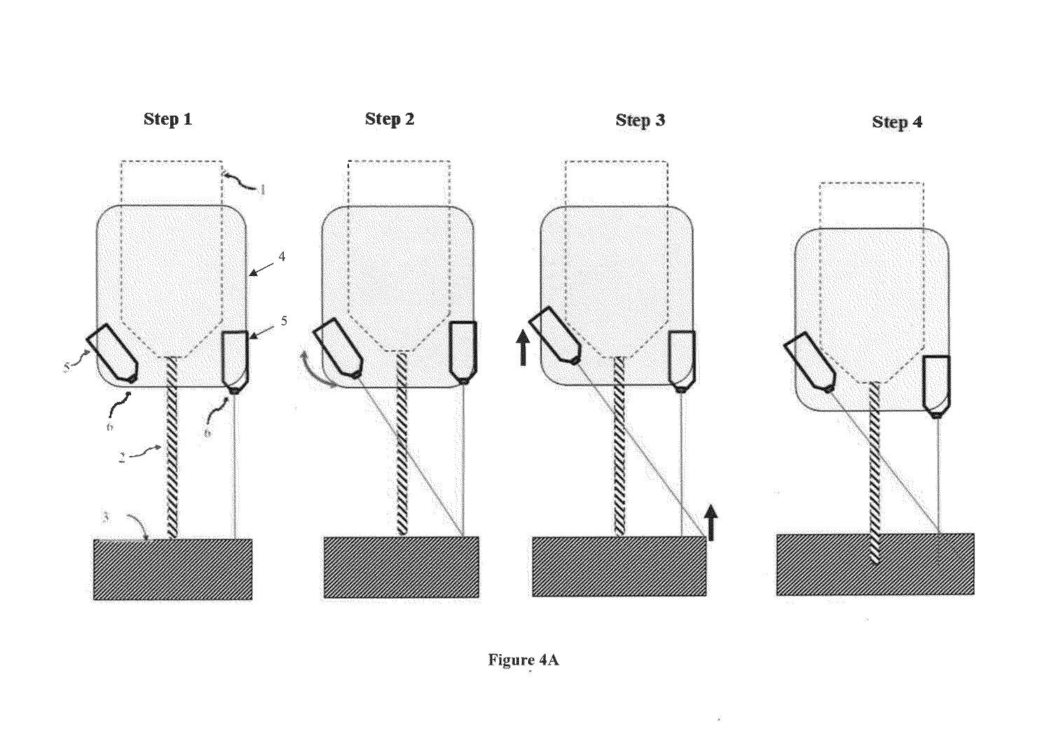

FIG. 4 shows how the depth of the drilled hole may be controlled though the use of creating a 45 degree reference triangle, with one laser set at 45 degrees and the other at 0 degrees from the drill bit longitudinal axis. The 45 degree laser unit is adjusted vertically or parallel to the longitudinal axis of the drill bit to equal the same radius as the laser at 0 degrees. The 45 degree laser is then adjusted upward the desired distance or drill depth. As the drill descends the outer trace reduces in diameter. At the point where the outer and inner traces are equal in diameter—i.e., sit on top of one another—the hole has been drilled to the desired, measured level.

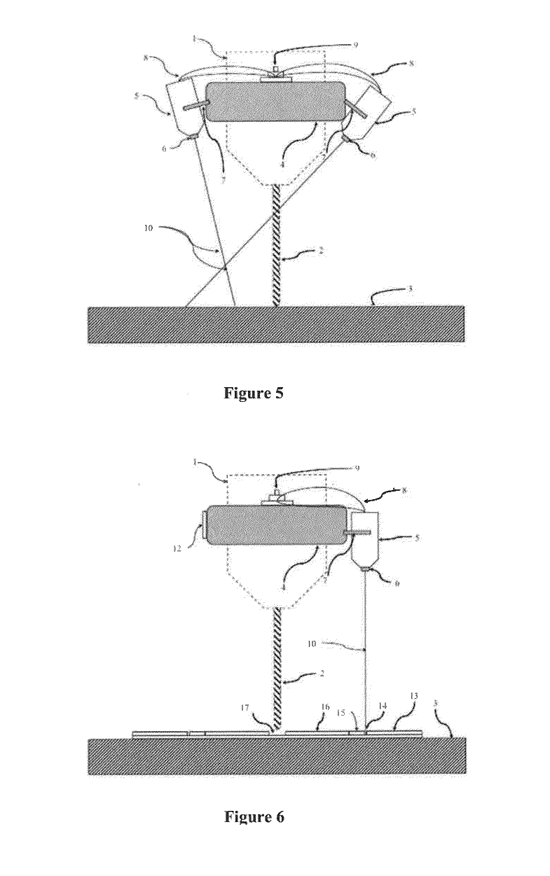

A second embodiment of the invention with fixed angles of the lasers, non-perpendicular to the work surface, that creates concentric circles near the drill bit, is shown in FIG. 5. The preferred angles for the lasers in this embodiment are one fixed angle (e.g., 15 degrees) and one 45 degree angle measured off the line parallel to the drill bit longitudinal axis. Other angles are also acceptable. This design eliminates the need for the operator to adjust the angle of incidence of the lasers for simpler operation.

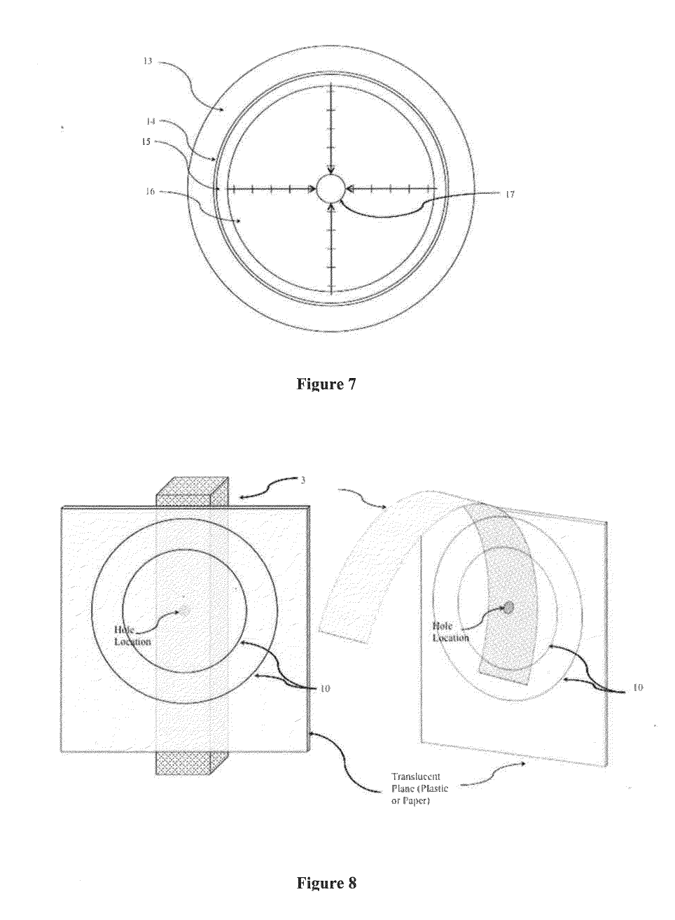

FIG. 6 shows a third embodiment of the invention utilizing a single laser, set a 0 degrees measured off the line parallel to the drill bit longitudinal axis used in conjunction with the track template as shown in FIG. 7. The light trace is at fixed diameter parallel to the drill bit longitudinal axis and equal to the trace template, which acts as a target for the rotating beam. A perpendicular alignment will result in a steady illumination of the light on the reflective track and resultant dark spots if the drill bit alignment is not a perpendicular.

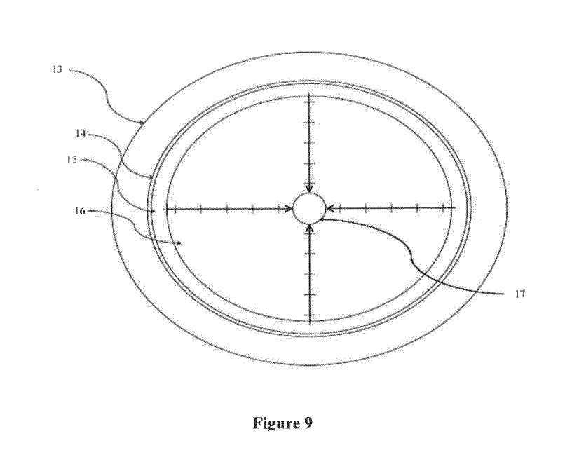

FIG. 8 demonstrates the use of a translucent plane to assist operators in utilizing the invention on work surfaces that are very small, narrow or have a complex topography.

FIG. 9 shows an illustrative design of an elliptical template that can be used with the invention to provide alignment when drilling non-perpendicular holes, e.g. 30, 45, 60, by setting the laser angles to 0 degrees

The above description of illustrated embodiments is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

Generally, in the following claims, the terms used should not be construed to limit the claims to the specific embodiments disclosed in the specification, but should be construed to include all possible embodiments along with the full scope of equivalents to which such claims are entitled.

1. A device for determining angle or depth of a drill bit when in use on a surface comprising:
at least one signal source that generates a signal that varies in response to changes in angle or depth of the drill bit, the signal source being capable of moving with rotation of the drill bit; and
a holder to which the signal source is attached, the holder being capable of being mounted to a drill chuck or being incorporated in a drill chuck and the holder being capable of moving with rotation of the drill bit.

2. The device of claim 1, wherein said signal source projects light and generates a pattern or shape as the signal, which changes in response to changes in angle or depth of the drill bit.

3. The device of claim 1 comprising a plurality of signal sources, each generating its own signal.

4. The device of claim 1 further comprising a second signal source that generates a fixed signal which essentially does not vary in response to changes in depth of the drill bit.

5. The device of claim 1, wherein said signal source comprises a light emitter selected from the group consisting of incandescent bulbs, fluorescent bulbs, lasers, and light emitting diodes (LED).

6. The device of claim 5, wherein said signal source comprises a laser.

7. The device of claim 6, wherein the laser generates light that forms a circular or elliptical pattern on the surface with rotation of the drill bit.

8. The device of claim 1, wherein the holder comprises means for mounting it on a drill chuck.

9. The device of claim 8, wherein the holder is a collar that is capable of being removeably mounted on a drill chuck and the signal source is adjustably attached to the holder.

10. The device of claim 9, wherein the collar has a rigid outer ring to which the signal source is attached, and a semi-rigid inner ring that is capable of sliding over and securely attaching to the drill chuck.

11. The device of claim 1 further comprising at least one power source for powering the signal source, said power source being attached to the signal source or the holder or being incorporated in the signal source or holder.

12. A device that attaches to a drill chuck of a hand drill which can be used for aligning a drill bit or determining its depth with respect to a surface, the device comprising:
a signal source that projects a light beam; and
means for attaching said signal source to the drill chuck whereby the light beam creates an image on the surface and the image can be used to assess orientation or depth of the drill bill with respect to the surface.

13. The device of claim 12, wherein the signal source is a laser.

14. The device of claim 12, wherein said signal source can be pivoted, angled and/or moved vertically and horizontally with respect to the drill chuck.

15. A method of determining the angle or depth of a drill bit with respect to a work piece surface, the method comprising:
inserting the drill bit into a drill chuck;
mounting a holder onto the drill chuck, the holder being capable of moving with rotation of the drill bit;
attaching a signal source to the holder, the signal source being capable of moving with rotation of the drill bit and of generating an image that changes with angle or depth changes of the drill bit;
generating the image while drill is in use; and
using the image to orient the angle of the drill bit or to determine the depth of the drill bit with respect to the work piece surface.

16. The method of claim 15, wherein the signal source is a laser and the image comprises two concentric circles or two ellipses and wherein varying the drill bit angle or depth changes the shape of the circles or ellipses or changes the distance between them.

17. The method of claim 16, wherein the method is for determining the angle of the drill bit and wherein the two concentric circles are formed when the drill bit is perpendicular to the work piece surface, and ellipses or deformation of the circles occurs when the drill bit is not perpendicular to the work piece surface.

18. The method of claim 16, wherein the method is for determining the depth of the drill bit and wherein one circle or ellipse is generated from a light signal source at a 45 degree angle to the drill bit longitudinal axis, and the other circle or ellipse is generated from a laser at a 0 degree angle to the drill bit longitudinal axis.

19. The method of claim 15, wherein the image is generated on the work piece surface.

20. The method of claim 15, wherein the image is generated on a remote surface, on a template, or as a transmission to an electronic device.

21. The device of claim 1, wherein the holder or the signal source is integral to the drill chuck.

22. The method of claim 16, wherein the method is for determining the depth of the drill bit and wherein one circle or ellipse is generated from a signal source at a 0 degree angle to the drill bit longitudinal axis and the other circle or ellipse is generated from a signal source at an angle other than 0 degree angle to the drill bit longitudinal axis

23. A drill having a means for aligning a drill bit or determining its depth with respect to a surface to be drilled, the drill comprising:
a drill chuck;
a signal source attached to or integral to the drill chuck, the signal source being capable of projecting a light beam onto the surface being drilled or onto a reference surface; and
wherein the light beam creates an image on the surface or on the reference surface and the image can be used to assess orientation or depth of the drill bill with respect to the surface being drilled.
